(19) United States
(12) Patent Application Publication
(10) Pub. No.: US 2004/0159090 A1
(43) Pub. Date: Aug. 19, 2004

(54) Hydromagnetic inertial propulsion

(76) Inventor: Harold A. Tavarez, Long Beach, CA (US)

Correspondence Address: Harold A. Tavarez, Apt. 2, 2501 East 4th Street, Long Beach, CA, 90814, US

(21) Appl. No.: 10/369,296

(22) Filed: Feb. 18, 2003

(51) Int. Cl. F02K 1/00

(52) U.S. Cl. 60/200.1

(57) ABSTRACT

A Hydromagnetic inertial thruster (10) comprising a centrifugal force generator (18), a plurality of electromagnets (22), a hydromagnetic fluid (36), and a stator housing (12) to support the operation of the centrifugal generator (18). The plurality of electromagnets (22) generates a magnetic field (Hₒ) to attract and hold a mass of a magnetically susceptible fluid (36).The centrifugal rotor (18) and the electromagnets (22) while generating the magnetic field (Hₒ) rotate together with the mass of fluid (36) for about one half of a cycle of revolution to generate an unbalanced centrifugal force (F_{c}) with the fluid (36). The vector sums of all the centrifugal force (F_{c}) vectors become a directional propulsion force (Fₚ).

### BACKGROUND

1. Field of Invention

This invention relates to employing the centrifugal forces in a fluid to generate a directional propulsion force.

2. Description of Prior Art

It is recorded in the prior art that a centrifugal force can be used as a source of propulsion for various means of transportation. In order to generate a directional force, a means to convert a centrifugal force to a directional propulsion force must be employed. From the efforts of the past to recent efforts in the field, the main focus has been on the use of solid masses, gears, and arms to generate a directional linear force for propulsion.

One method for producing a directional force consists in varying the radius of gyration of rotating masses for a predetermined part in their cycle of revolution. Another method consists of exchanging masses between sets of counter rotating arms to generate an unbalanced centrifugal force. Another related mechanism comprises one or more swingable shafts, weighed arms and masses rotating about a main shaft. Various machines and devices employing these means and methods have been proposed. However successful these methods and means for generating unidirectional and unbalanced centrifugal forces may be, they all suffer from many serious disadvantages and limitations. These machines are exceedingly complex mechanisms. They require critically synchronized and complex driving mechanisms for rotating the masses that generate the unbalanced centrifugal forces. And at best, they only generate a discontinuous pulse of thrust as predetermined by the degree of separation between the rotating masses.

### SUMMARY OF THE INVENTION

The present invention employs the centrifugal forces in a fluid to generate a directional and continuous propulsion force. The invention consists of a directional force generator comprising a static housing with a rotating centrifugal force platform supporting a mass of fluid. One full cycle of platform rotation equal 360°. During the operation of one thrust cycle, the centrifugal force platform carries the fluid only a part of the cycle. For that part of the cycle, the rotating platform generates unbalanced centrifugal forces with the fluid. The vector sum of all the one-sided unbalanced centrifugal forces in the fluid generates a directional propulsion force. For the remainder of the cycle, the fluid departs from the rotating platform into a pathway in the stator housing. During the second part of the cycle, the fluid does not generate significant opposing forces as it travels through the stator pathway. By employing this method of operation, for approximate one half of the propulsion thrust cycle, the fluid generates unbalanced centrifugal forces on only one side of the centrifugal platform. On the other half of the cycle, the fluid in the stator pathway generates insufficient opposing forces to cancel the unbalanced centrifugal forces. By repeating the operation of the thrust cycle with the same fluid, a directional propulsion force can be generated continuously. The entire operation is a suitable source of propellantless and unidirectional thrust useful for propulsion. The directional propulsion thruster of this invention can be attached to the chassis of a vehicle to generate motion for transportation. The invention is useful as an application for the propulsion of railway cars, passenger cars, trucks, aviation, marine ships, spacecrafts and the like.

### BRIEF DESCRIPTION OF THE DRAWINGS

FIG. 1 is a plan view of a hydromagnetic inertial thruster.

FIG. 2 is a cross sectional view of the hydromagnetic inertial thruster showing an internal view of a magnetic field supporting a magnetic fluid to generate the centrifugal forces that generate an inertial propulsion force.

FIG. 3A describes a hydromagnetic fluid flow in a hydrodynamic stator channel.

FIG. 3B illustrates a centrifugal force platform and a magnetic field supporting a mass of hydromagnetic fluid rotating together to generate a propulsion force.

FIG. 3C describes a propulsion thrust cycle.

FIG. 4 shows an improved hydromagnetic inertial thruster by adding a vertical annular wall to the centrifugal force generator.

FIG. 5 shows a modified hydrodynamic stator to support the operation of the vertical wall added to the centrifugal generator shown in FIG. 4.

FIG. 6 shows a hydromagnetic fluid rotating with a centrifugal platform as it relates to FIG. 4.

FIG. 7 illustrates a further improvement of the hydromagnetic inertial thruster shown in FIG. 4. An annular horizontal floor has been added.

FIG. 8A shows a view of the centrifugal platform with the annular floor introduced in FIG. 7.

FIG. 8B is a view of FIG. 7 with a cut out to show the operation of a centrifugal platform with a magnetic field supporting a mass of hydromagnetic fluid to produce the centrifugal forces that generate a propulsion force.

FIG. 8C shows a construction view of a hydromagnetic stator for the improved hydromagnetic thruster introduced in FIG. 7.

FIG. 9 is an improved hydromagnetic inertial thruster. Instead of an electronic source of magnetic field, a ring shaped magnet act as a source of magnetic field.

FIG. 10 is a cross sectional view of the hydromagnetic inertial thruster shown in FIG. 9.

FIG. 11A shows the magnetic field distribution of a magnet on a centrifugal rotor to support a mass of hydromagnetic fluid.

FIG. 11B shows the propulsion thrust cycle in a hydromagnetic inertial thruster with a magnet.

FIG. 12 shows an improved version of the hydromagnetic inertial thruster described in FIG. 9 and 10. A vertical annular wall has been added to the centrifugal generator.

FIG. 13 illustrates a further improvement on the thruster shown in FIG. 12. A horizontal annular floor has been added.

FIG. 14 is another improvement of the hydromagnetic inertial thruster.

FIG. 15 shows an internal cross sectional view of the hydromagnetic inertial thruster in FIG. 14.

FIG. 16A shows the hydromagnetic propulsion operation in the centrifugal platform employed in FIG. 15.

FIG. 16B shows the hydromagnetic propulsion operation in the stator and in the centrifugal rotor superimposed in the stator chamber to show a hydromagnetic propulsion thrust cycle.

FIG. 17 is a top plan view of a hydrodynamic inertial thruster.

FIG. 18 shows a lateral cross section of the hydrodynamic inertial thruster shown in FIG. 17.

FIG. 19A is a view of a hydrodynamic stator for the improved hydrodynamic inertial thruster introduced in FIG. 17.

FIG. 19B shows the operation of a centrifugal platform with a mass of fluid generating the centrifugal forces that generate a directional propulsion force.

FIG. 19C shows a propulsion thrust cycle in a hydrodynamic inertial thruster.

### METHOD OF OPERATION

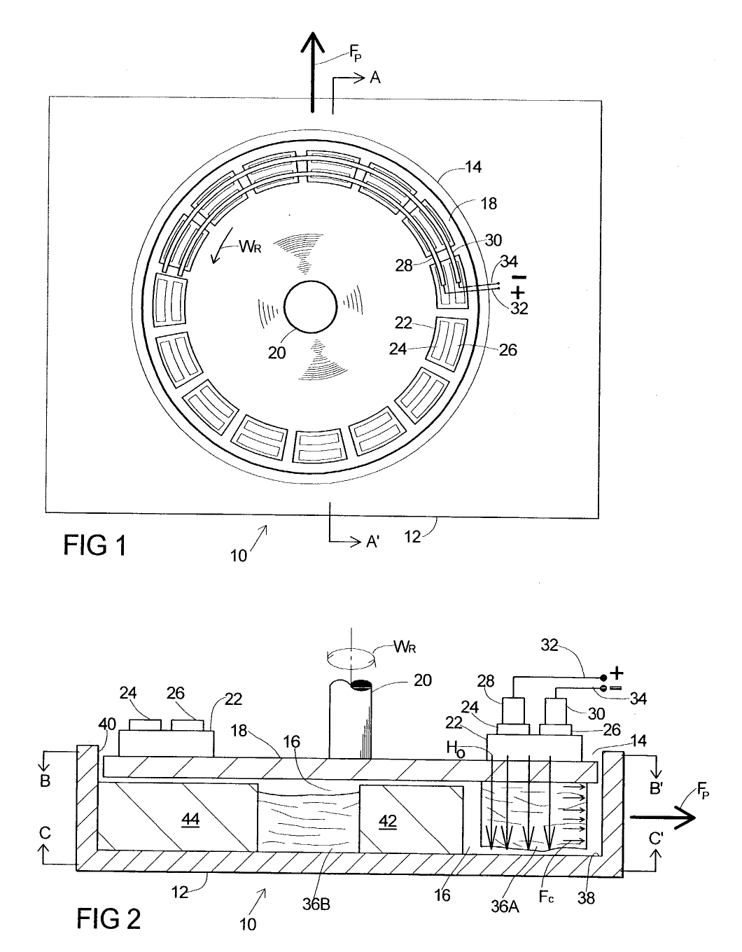

FIG. 1 is a plan view of a hydromagnetic inertial thruster 10 comprising a hydrodynamic stator 12, a stator chamber 14, a centrifugal force generator 18, a generator shaft 20, an electromagnet 22 (a total of fifteen electromagnets are shown in this drawing), electric contacts 22 and 26, electric brushes 28 and 30, electric conductors 32 and 34, an angular velocity W_{R}, and a directional propulsion force Fₚ. The stator 12 houses a centrifugal force generator 18 attached to the generator shaft 20. The shaft 20 is attached to a motor (not shown). The motor (not shown) provides the torque to rotate the generator 18 counterclockwise. A plurality of electromagnets 22 (only one electromagnet is numbered) with the electric contacts 24 and 26 are provided to transfer electricity to the electromagnet 22. A pair of electric brushes 28 and 30, each with a corresponding electric conductors 32 and 34 connect to an external electric power source represented with the symbols + and −. The centrifugal generator 18 rotates counterclockwise with the angular velocity W_{R} to generate a directional propulsion force Fₚ.

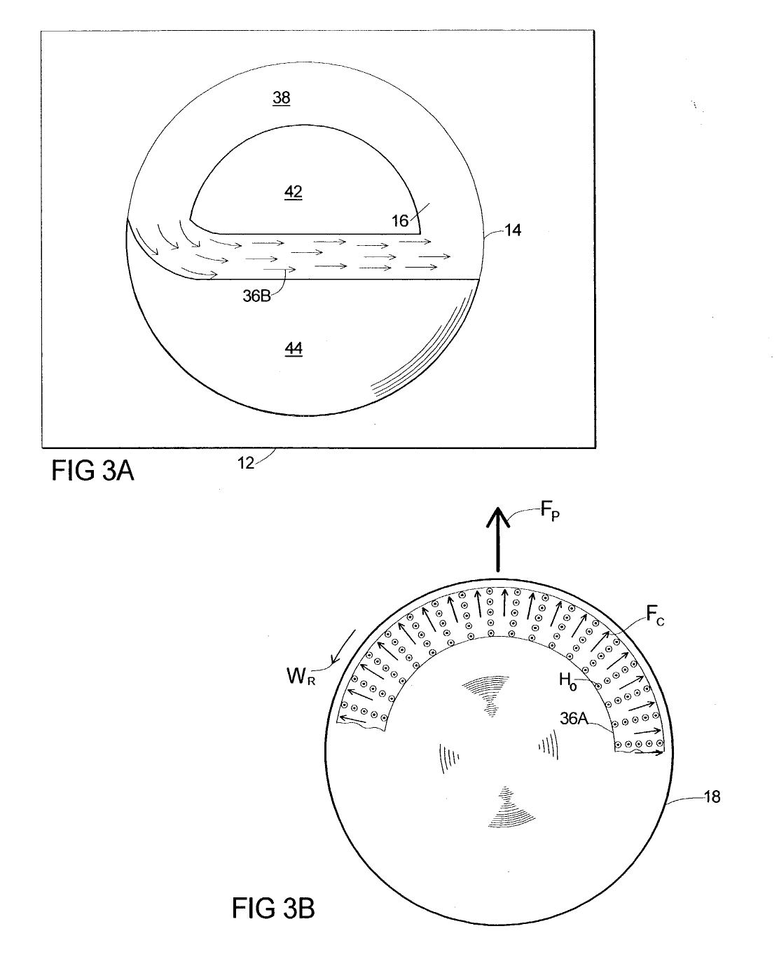

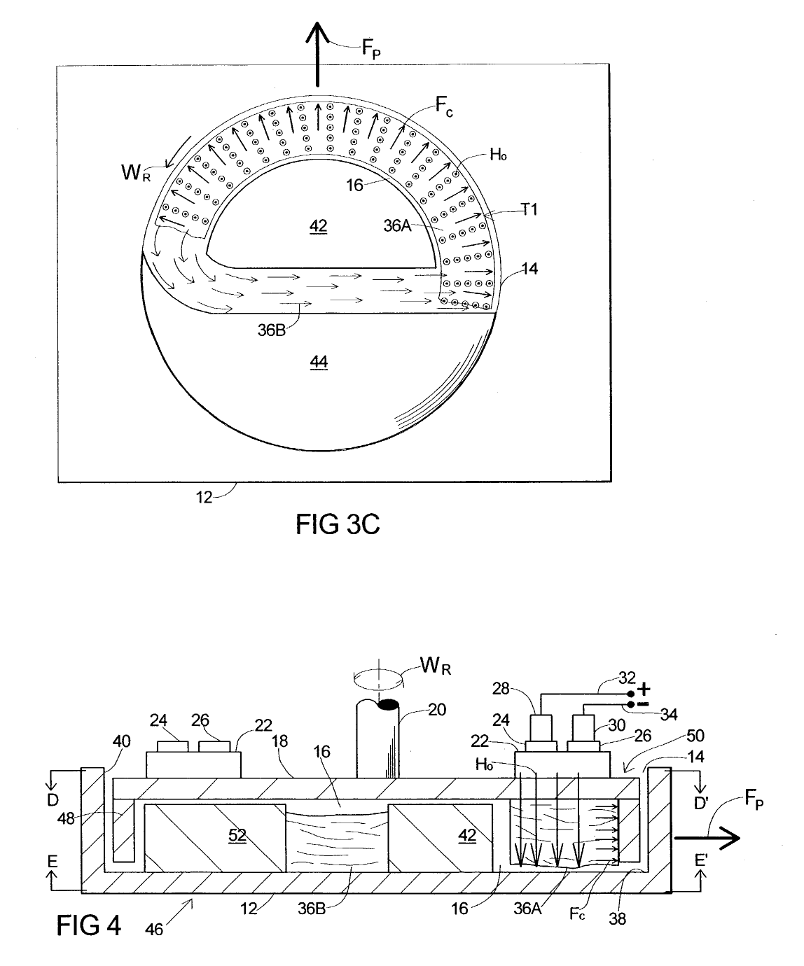

FIG. 2 is a lateral cross sectional view of FIG. 1 taken along the line AA′. FIG. 2 shows a hydromagnetic inertial thruster 10 comprising a hydrodynamic stator 12 with a stator chamber 14 and a closed circuit channel 16. The stator chamber 14 has a chamber floor 38 and a chamber wall 40. The chamber 14 also has a front island 42 and a rear island 44. Both islands 42 and 44 help to define the closed circuit shape of the channel 16. The shape of the closed circuit channel 16 is also shown in FIG. 3A. In the stator 12, the stator chamber 14 houses a centrifugal force generator 18 attached to a generator shaft 20. The shaft 20 is attached to a motor that is not shown and provides the torque to rotate the generator 18 with an angular velocity W_{R}. A plurality of electromagnets 22 (only two are shown) with electric contacts 24 and 26 are provided to transfer electric power to the electromagnets 22. A set of brushes 28 and 30, each with a corresponding electric conductor 32 and 34 connect to an external electric power source represented with the symbols +and −. Each of the electromagnet contacts 24 and 26 make a direct connection with a corresponding electric brush 28 and 30 to transfer power to any electromagnet 22 in order to generate a magnetic field Hₒ. On the right side of FIG. 2, the magnetic field Hₒ acts as a magnetic container to attract and hold a mass of hydromagnetic fluid 36A. A second phase of hydromagnetic fluid 36B is shown between the islands 42 and 44. On the right side of FIG. 2, the phase of fluid 36A shows a body of centrifugal forces F_{c} marked with arrows. In general, the hydromagnetic fluid will be referred to with the numeral 36. For this invention, a hydromagnetic fluid is defied as a colloidal ferrofluid or any other type of fluid that generates a substantial response in the presence of a magnetic field. As it occurs in the invention, the hydromagnetic fluid 36 has two phases. The phase of hydromagnetic fluid in the generator 18 under the influence of the magnetic field Hₒ will be referred with the numeral 36A. While the numeral 36B will refer to the phase of hydromagnetic fluid in the stator chamber 14 and is free from the influence of the magnetic field Hₒ. The centrifugal force generator 18 rotates counterclockwise with an angular velocity W_{R} to generate a directional propulsion force Fₚ.

The stator chamber 14 is a hollow depression in the body of the hydrodynamic stator 12. The chamber 14 is defined by the boundaries of the space between the floor 38 and the wall 40. The hydrodynamic stator 12, with the stator chamber 14 and the stator islands 42 and 44 defining the closed circuit channel 16, provides the means to support the propulsion operation of the centrifugal force generator 18. These entities cooperate together in the propulsion operation to generate the directional propulsion force Fₚ.

Referring to FIGS. 1 and 2, to generate a directional propulsion force Fₚ, a centrifugal force generator 18 attached to the generator shaft 20 rotates with the angular velocity W_{R} in the stator chamber 14. The generator 18 is a disk shaped rotor. On one face of the generator 18, a plurality of electromagnets 22 acting as a source for a magnetic field Hₒ are installed. The electromagnets 22 shown in the FIGS. 1 and 2 are only a symbolic representation of sources of electromagnetic field since there are so many types. The theory and function of electromagnets is well known in the art, and therefore its explanation will omitted here. Therefore, the invention is not limited to only one type of source of magnetic field from electricity. As the generator 18 rotates counterclockwise, several of the electromagnets 22, though the electric contacts 24 and 26 make a connection with a set of electric brushes 28 and 30. As each of the electromagnet 22 receives electricity from a power supply, each electromagnet 22 generates a magnetic field Hₒ accordingly. As each electromagnet 22 generates its own magnetic field Hₒ, each electromagnet 22 captures a mass of hydromagnetic fluid 36B and change to the phase of hydromagnetic fluid 36A. Using the face of an analog clock as a reference, in FIG. 1, the three o'clock position represents the 0° position and the nine o'clock position represents the 180° position.

To describe how the directional propulsion force Fₚ is produced; and to show how the thrust output cycle in the stator chamber 14 and in the centrifugal force generator 18 operates, the explanation will start by following the journey of one electromagnet 22 translation for an entire thrust cycle. Starting at the approximate and initial position of 0° and ending at the approximate 180° position. At the approximate 0° position, as shown in FIG. 1, an electromagnet 22 through the electric contacts 24 and 26 comes in contact with the power brushes 28 and 30. The electromagnet 22 becomes energized with electricity and generates the magnetic field Hₒ as seen in FIG. 2. Beginning with FIG.2 and in all the relevant drawings, the magnetic field Hₒ will be represented with straight arrows for convenient of graphical representation only. The brushes 28 and 30 as shown in FIG. 1 are sufficiently long enough to cover the simultaneous operation of several electromagnets 22 as they travel to the approximate 180° position.

In FIG.2, the magnetic field Hₒ supports of a mass of hydromagnetic fluid 36A. As a result, the local weight of the centrifugal generator 18 increases in the vicinity where the powered electromagnet 22 supports the mass of fluid 36A. As the loaded electromagnet 22 on the generator 18 rotates counterclockwise with the angular velocity W_{R}, the mass of fluid 36A generates additional centrifugal forces F_{c}, as symbolized with arrows in FIGS. 2, 3B and 3C. Normally, without the added weight of the fluid 36A, the plurality of electromagnets 22 and the centrifugal generator 18 are well balanced as they rotate together. The centrifugal generator 18 is a circular disk shaped rotor. When an electromagnet 22 is energized, it generates the magnetic field Hₒ that attracts and holds a mass of hydromagnetic fluid 36A. The added weight of the fluid 36A increases the local weight of the generator 18. As a result, an additional output of centrifugal forces F_{c} creates an imbalance of centrifugal forces F_{c} on one side of the generator 18. As the fluid 36A loaded electromagnet 22 continues to travel towards the approximate 180° position, the mass of fluid 36A generates the additional centrifugal forces F_{c} as seen in the FIGS. 2, 3B and 3C. In FIGS. 3B and 3C, the magnetic field Hₒ is shown coming out of the page oriented toward the viewer. The field Hₒ is represented as circles with dots in the center. At the approximate 180°, the electromagnet 22 breaks contact with the brushes 28 and 30 and terminate the function of the magnetic field Hₒ. The hydromagnetic fluid phase 36A, free from the effect of the magnetic field Hₒ becomes the phase of hydromagnetic fluid 36B. The fluid phase 36B is shown in FIG. 2 between the chamber islands 42 and 44, and in FIG. 3A and 3C. From the approximate 180° and onwards, the electromagnet 22 turns off and continues traveling in a semicircular orbital path towards the final position to start the cycle again. In this part of the cycle of revolution, the electromagnet 22 remains off, without power, without a magnetic field Hₒ and without any fluid 36A attached. In the chamber 14, the rear island 44 acts as an obstruction and a border to deflect and guide the fluid 36B in the straight section of the channel 16. In FIG. 2, the body of fluid 36A is shown free of contact from the chamber floor 38 and the chamber wall 40 to minimize the frictional forces between these three components. The volume of the chamber island 44 also prevents much of the fluid 36B from flowing outside the channel 16. The explanation continues with the description of FIGS. 3A, 3B and 3C.

FIGS. 3A, 3B and 3C are further expressions of FIGS. 1 and 2. FIG. 3A is plan view of the hydromagnetic stator 12 taken along the line BB′ of FIG. 2. The stator 12 is isolated to show the fluid dynamic operation only in the stator chamber 14. FIG. 3B shows the fluid dynamic thrust operation in a centrifugal force generator 18. FIG. 3C is a summary of the propulsion thrust cycle operation in both FIG. 3A and FIG. 3B.

FIG. 3A shows a hydrodynamic stator 12, a stator chamber 14, a closed circuit channel 16, a chamber floor 38, a front islands 42, and a rear island 44. A phase of hydromagnetic fluid 36B flowing over the chamber floor 38 and between the islands 42 and 44. In the straight section of the channel 16, the fluid 36B flows without the influence of the magnetic field Hₒ.

FIG. 3A is an isolated view of only the hydrodynamic stator 12 taken along the line BB′ of FIG. 2. FIG. 3A is isolated to show the fluid dynamic operation taking place in a section of the closed circuit channel 16. In the channel 16, the phase of hydromagnetic fluid 36B is free from the magnetic field Hₒ influence. To generate an imbalance of centrifugal forces on only one side, the centrifugal generator 18 transport the mass of fluid 36A for about 180° in the orbital path of a semicircle. At the approximate 180°, the magnetic field Hₒ releases the mass of fluid 36A and it becomes the phase of fluid 36B. The phase of fluid 36B then encounters the rear island 44. The island 44 receives the fluid 36B and turns it in a new direction as shown with arrows. As the fluid 36B travels in the channel 16 from the left to the right side, over the chamber floor 38 and between the chamber islands 42 and 44, the fluid dynamic laws of Bernoulli's principle govern the fluid 36B motion. That would indicate that, the fluid 36B velocity and the pressure distribution can be defined by the channel's 16 profile and area distribution in the section between the islands 42 and 44. Inside the stator chamber 14, as the mass of fluid 36B travels in the back section of the channel 16, it generates a minimum amount of opposing forces that subtracts from the total directional propulsion force Fₚ.

FIG. 3B is a description of the operation in the centrifugal force generator 18 taken along the line CC′ of FIG. 2. FIG. 3B shows a centrifugal force generator 18 supporting a mass of hydromagnetic fluid 36A with a magnetic field Hₒ. The generator 18, together with the fluid mass of fluid 36A rotates with an angular velocity W_{R}. As the generator 18 rotates with the mass of fluid 36A, it generates in the fluid 36A the centrifugal forces F_{c} as shown with radial arrows. The vector sums of all the centrifugal forces F_{c} in the fluid 36A generate a directional propulsion force Fₚ. The generator 18 has a disk shape.

FIG. 3B shows a centrifugal force generator 18 rotating counterclockwise with the angular velocity W_{R} while supporting a mass of hydromagnetic fluid 36A with a magnetic field Hₒ. Following convention, the magnetic field Hₒ is shown as circles with dots in the middle since the field Hₒ comes out of the page. The solid and the jagged lines describe the boundaries of the mass of fluid 36A on the face of the generator 18. In FIG. 3B, a plurality of magnetic field lines Hₒ are arranged in a semicircle. As the figure shows, from the approximate 0° to the approximate 180° position, only some of the electromagnets 22 (located on the back of the generator 18) receive electricity to generate the magnetic field Hₒ. While the rest of the electromagnets 22 are turned off as seen by the absence of the magnetic field Hₒ lines in the rest of the disk. The result on that part of the propulsion thrust cycle produces the centrifugal forces F_{c} in the fluid 36A as shown with radial arrows. The vector sums of all the force vectors F_{c} becomes the directional propulsion force Fₚ. As one and more of the electromagnets 22 rotate around in a circle; an electromagnet 22 is loaded with the additional weight of fluid 36A to generate the unbalanced centrifugal force F_{c} component. Several electromagnets 22 operating simultaneously for only a part of the propulsion thrust cycle generates the output of a continuous and directional propulsion force Fₚ. As FIG. 3B shows; the mass of fluid 36A travels in a semicircular orbital path driven by the centrifugal generator 18 at the angular velocity W_{R}. In the operation of the generator 18 loaded with a mass of fluid 36A, the magnitude of the centrifugal forces F_{c} are related to the mass of fluid 36A, the square of the angular velocity W_{R}, and the radius of the semicircular path the mass of fluid 36A travels. The explanation continues in FIG. 3C.

In FIG. 3C, the part of the propulsion thrust cycle taking place in the centrifugal generator 18 and in the hydrodynamic stator 12 are superimposed together in the stator chamber 14. FIG. 3C is a visual summary description of the fluid dynamic operations in both, the centrifugal force generator 18 and the hydrodynamic stator 12 as described in FIGS. 3A and 3B. Both phases of fluid 36A and 36B are superimposed on the stator channel 16 for purposes of explanation only. FIG. 3C shows a hydromagnetic stator 12 with a stator chamber 14, a closed circuit channel 16, a phase of hydromagnetic fluid 36A and a second phase of fluid 36B, a front island 42 and a rear island 44, a magnetic field Hₒ, an angular velocity W_{R} vector, a plurality of centrifugal force F_{c} vectors marked with radial arrows, a directional propulsion force Fₚ and a propulsion thrust cycle T1.

FIG. 3C is a visual representation of the hydromagnetic propulsion thrust cycle T1 and can be explained as follows. In FIG. 3C, the centrifugal fluid dynamic operation in the centrifugal force generator 18 is combined with the fluid dynamic operation in the stator chamber 14 to show a propulsion thrust cycle T1. Both fluid dynamic operations are combined and superimposed in the stator channel 16 to explain the thrust cycle T1. FIG. 3C is also a comparison and contrast between the operations in the phases of hydromagnetic fluid 36A and 36B. FIG. 3C shows the effects the rotating centrifugal generator 18 and the magnetic field Hₒ exert on the phase of fluid 36A. Typically, in a magnetic field, a hydromagnetic fluid or a ferrofluid in general will behave as if it were a solid. A magnetized ferrofluid can form a barrier, or a seal that will act as if it were a solid obstacle. Similarly, by applying the magnetic Hₒ to the phase of fluid 36B as it arrive to the right side of the channel 16; the fluid 36B enters the generator 18 and becomes the phase of hydromagnetic fluid 36A. In the generator 18, the fluid 36A acts as if it were a solid mass of fluid. The field Hₒ captures the mass of fluid 36A and transports it in a semicircular orbital path from an initial starting position, to a final destination (at about 180° away). At the final destination, the field Ho, disappears releasing the mass of fluid 36A. As the inertial mass of the fluid 36A travels in a semicircular path with the angular velocity W_{R}, the fluid 36A generates the centrifugal force Fc as shown with radial arrows. The length of the volume of fluid 36A is due to the simultaneous operation of several sources of magnetic field, the electromagnets 22. For that share of the thrust cycle T1, the rotational motion generates the centrifugal forces F_{c} in the mass of fluid 36A. Ideally in this case; the mass of fluid 36A is stationary and does no have a relative velocity with respect to the generator 18 as the magnetic field Hₒ holds it and carries it along for the ride in a semicircular orbit.

In contrast to the operation of the phase of fluid 36A, the phase of fluid 36B flows in the stator 12 in a liquid form. At the end of the fluid 36A journey, the magnetic field Hₒ vanishes and releases it to liquefy into the phase of hydromagnetic fluid 36B. The mass of fluid 36B encounters the rear island 44. The island 44 receives the fluid 36B and then turns it in a new direction. The mass of fluid 36B then travels from the point of release to the other side of the closed circuit channel 16 where it meets the magnetic field Hₒ once again. Inside the stator chamber 14, the phase of fluid 36B is shown with arrows as it travels in that part of the channel 16. In that part of the thrust cycle T1, the phase of hydrodynamic fluid 36B is a liquid in motion. The hydrodynamic shape of the channel 16 between the chamber islands 42 and 44 dictates the fluid dynamic behavior of the fluid phase 36B as it moves along. In the drawings, part of the channel 16 has the shape of a straight duct. While another part of the channel 16 is arched to change the fluid 36B direction. On the left side of the channel 16 where the flow of fluid 36B starts to turn, the fluid 36B generates a negative turning force that subtract from the total centrifugal thrust output of the generator 18. The hydrodynamic profile in that part of the channel 16 determines the magnitude of the turning force. For example, if a singular or a cascade of airfoils or turning vanes were inserted in the arched section to turn the flow of fluid 36B, then the magnitude of the turning force would depend on the fluid dynamic characteristics of the airfoil or vane cascade section. The net effect of the turning force is a reduction in the total amount of thrust available for propulsion. Nevertheless, the vector magnitude of the force exerted by the turning fluid 36B is much less than the propulsion force component Fₚ. This is in essence part of the operation of the propulsion thrust cycle T1. The totality of the thrust cycle T1 is made up by the sum all the forces produced in the stator 12 and in the centrifugal generator 18.

By examining the thrust cycle T1 in FIG. 3C, one difference about the path the fluid phases 36A and 36B follow in the stator chamber 14 become obvious. And that is, with respect to a center, the orbital radius of gyration for the phase of fluid 36A is much larger than the radial path the fluid 36B follows. The difference in the radial path length in the channel 16 is an indication of a differential in the forces generated between the two hydromagnetic fluid phases 36A and 36B. In addition, the forces generated by the phase of hydromagnetic fluid 36A are centrifugal in origin. While for the phase of fluid 36B may not be necessarily so. Therefore, the output of the centrifugal forces generated by the mass of fluid 36A is much larger the opposing forces generated by the phase of fluid 36B in the stator 12.

As FIG. 3C illustrates, the operation of the hydromagnetic fluid 36A and 36B is a continuous process and is expressed by the thrust cycle T1. Initially, a selected plurality of electromagnets 22, through the contacts 24 and 26 in electric contact with the brushes 28 and 30 receive electricity from a power supply and turn on to generate the magnetic field Hₒ. Each electromagnet 22 rotates, from an initial position where it turns on and captures a mass of fluid 36B with the magnetic field Hₒ, to a final location where it turns off to releases the mass of hydromagnetic fluid 36A. During the rotational translation part of the thrust cycle T1, the inertial laws of centrifugal motion operate to generate the centrifugal forces F_{c}. The vector sum of the centrifugal forces F_{c} generates the directional propulsion force Fₚ. In the second part of the thrust cycle T1, the phase of fluid 36A, free from the magnetic field Hₒ influence liquefies into the fluid phase 36B. In this part of the thrust cycle T1, the hydromagnetic fluid phase 36B flows like a liquid and does no produce significant opposing forces to cancel the propulsion force Fₚ. As the operation of the propulsion thrust cycle T1, a phase of hydromagnetic fluid 36A first travels with a powered electromagnet 22 to an approximate distance of 180° to be released. From the fluid 36A release position, the second part of the thrust cycle T1 takes place. The phase of fluid 36A liquefies into the phase of fluid 36B and travels in the channel 16 over the chamber floor 38 and between the islands 42 and 44 to a final destination; where once again, the hydromagnetic fluid 36B meets a powered electromagnet 22 with a magnetic field Hₒ to become the hydromagnetic fluid phase 36A; and the centrifugal thrust cycle repeats again. The hydromagnetic fluid phases 36A and 36B operate continuously. The totality of the propulsion thrust cycle T1 is made up by the sum all the forces produced in the stator 12 and in the centrifugal force generator 18. As the reader can see, as a propulsion thrust cycle this particular operation of employing the centrifugal forces in a hydromagnetic fluid is a novel concept.

The next descriptions are improvements and ramifications of the operation described above. For the illustrations that follow, like parts have the same numerals and new parts will have new numerals.

In this disclosure, the terms left and right, vertical and horizontal, are used in reference to the orientation of the drawings.

FIG. 4 is an improvement on the hydromagnetic inertial thruster 10. Using FIG. 2 as the starting point, FIG. 4 shows the cross section of a hydromagnetic inertial thruster 46 comprising the assembly of a hydrodynamic stator 12 and a centrifugal platform 50. The centrifugal platform 50 is comprised by a centrifugal generator 18 and a centrifugal thrust wall 48. FIG. 4 shows a hydrodynamic stator 12, a stator chamber 14 with a chamber floor 38, a chamber wall 40, a front island 42 and a second rear island 52. Both islands 42 and 52 help to define the shape of a closed circuit channel 16. The island 52 is designed to accommodate the operation of a centrifugal thrust wall 48 added to the generator 18 as an improvement. In the stator 12, the stator chamber 14 supports the operation of the centrifugal generator 18 attached to a generator shaft 20. The shaft 20 is attached to a motor that is not shown and provides the torque to rotate the generator 18 with an angular velocity W_{R}. A plurality of electromagnets 22 (only two are shown) each with electric contacts 24 and 26 are provided to transfer electric power to each electromagnet 22. A set of electric brushes 28 and 30, each with a corresponding electric conductor 32 and 34 connect to an external electric power source symbolized with the symbols +and −. As each electromagnet receives electricity it generates a magnetic field Hₒ. On the right side of FIG. 4, the magnetic field Hₒ acts as a magnetic container to attract and hold a mass of hydromagnetic fluid 36A. A second phase of hydromagnetic fluid 36B is shown on the floor 38 between the islands 42 and 52. On the right side of FIG.4, the phase of hydromagnetic fluid 36A shows a body of centrifugal forces F_{c} marked with arrows (only one arrow is labeled). The centrifugal force generator 18 rotates counterclockwise with an angular velocity W_{R} to generate the unbalanced centrifugal force F_{c} that becomes a directional propulsion force Fₚ. FIG. 4 shows an improved hydromagnetic inertial thruster 46. The improvement consists of a centrifugal thrust wall 48 added to the centrifugal generator 18 and assembled as the centrifugal platform 50. The previous rear island 44 has been replaced with a new rear island 52 to accommodate the operation of the vertical wall 48. The addition of the vertical wall 48 increases the magnitudes of the unbalanced centrifugal force F_{c} and the directional propulsion force Fₚ.

As the angular velocity W_{R} increases, the centrifugal force F_{c} also increase and push the hydromagnetic fluid 36A to move outwards and beyond the field Hₒ. In the hydromagnetic propulsion operation, while the magnetic field Hₒ is holding a mass of fluid 36A, it would be preferred that the fluid 36A not make contact with the chamber floor 38 or the chamber wall 40 to minimize the frictional forces. As the velocity W_{R} continues to increase, the centrifugal forces F_{c} in the fluid 36A will continue to increase and to press harder against the centrifugal thrust wall 48. The wall 48 has the shape of an annular ring installed perpendicular to the face of the generator 18. To accommodate the addition of the wall 48, the island 52 replaces the island 44. As a benefit to this modification, the improved centrifugal platform 50 operates at a higher angular velocity W_{R}. The higher angular velocity W_{R} increases the magnitude of the hydromagnetic inertial force Fₚ due to a similar increase in the magnitude of the unbalanced centrifugal force F_{c}.

FIG. 5 is a view of the hydrodynamic stator 12 taken along the line DD′ of FIG. 4. FIG. 5 shows a hydrodynamic stator 12, a stator chamber 14, a closed circuit channel 16, a chamber floor 38, a front island 42, and a rear island 52 designed to accommodate the operation of the centrifugal thrust wall 48 introduced as an improvement. FIG. 5 also shows a phase of hydromagnetic fluid 36B flowing over the floor 38 between the two islands 42 and 52. Even though a wall 48 is introduced in the thruster 46 design, the operation of the phase of hydromagnetic fluid 36B moving in the stator chamber 14 is similar as already discussed.

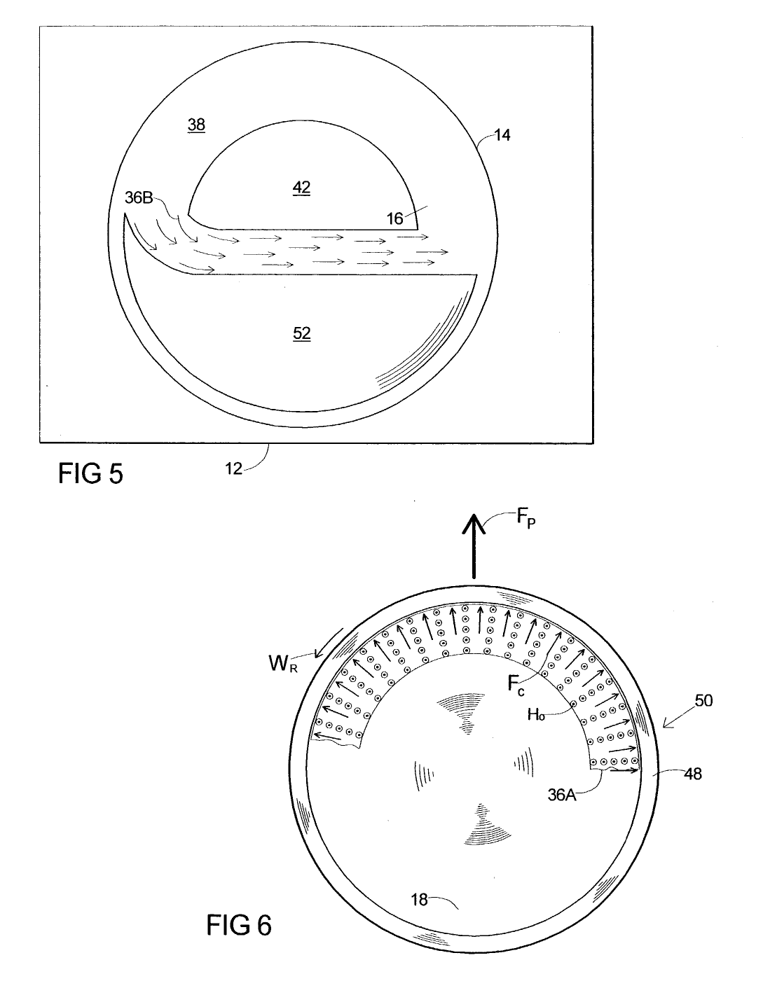

FIG. 6 is a view of a modified centrifugal force generator 18 taken along the line EE′ in FIG. 4. It shows an improved centrifugal platform 50. FIG. 6 shows a centrifugal force generator 18 rotating with an angular velocity W_{R}. The centrifugal platform 50 is comprised by the centrifugal generator 18 with a centrifugal thrust wall 48. FIG.6 shows a plurality of magnetic field lines Hₒ holding on to a mass of hydromagnetic fluid 36A. As the platform 50 rotates counterclockwise with the phase of fluid 36A, each element of fluid 36A generates a centrifugal force F_{c}. The body of fluid 36A pushes against the centrifugal thrust wall 48. The vector sums of all the unbalanced centrifugal force F_{c} components in the fluid 36A generate a directional propulsion force Fₚ. The sustained advantage of adding the vertical thrust wall 48 consists of a higher angular velocity W_{R} at which the centrifugal platform 50 operates. Instead of flying off, the mass of hydromagnetic fluid 36A stays magnetically attached to the centrifugal platform 50. As a benefit, a further gain in the magnitude of the unbalanced centrifugal force F_{c} output is achieved; with a further increase in the magnitude of the directional propulsion force Fₚ. The theory of operation for the hydromagnetic inertial thruster 46 is similar to the operation of the hydromagnetic inertial thruster 10, and both utilize the propulsion thrust cycle T1. A plan view of the thruster 46 is similar to the plan view of the thruster 10 shown in FIG. 1 and therefore omitted.

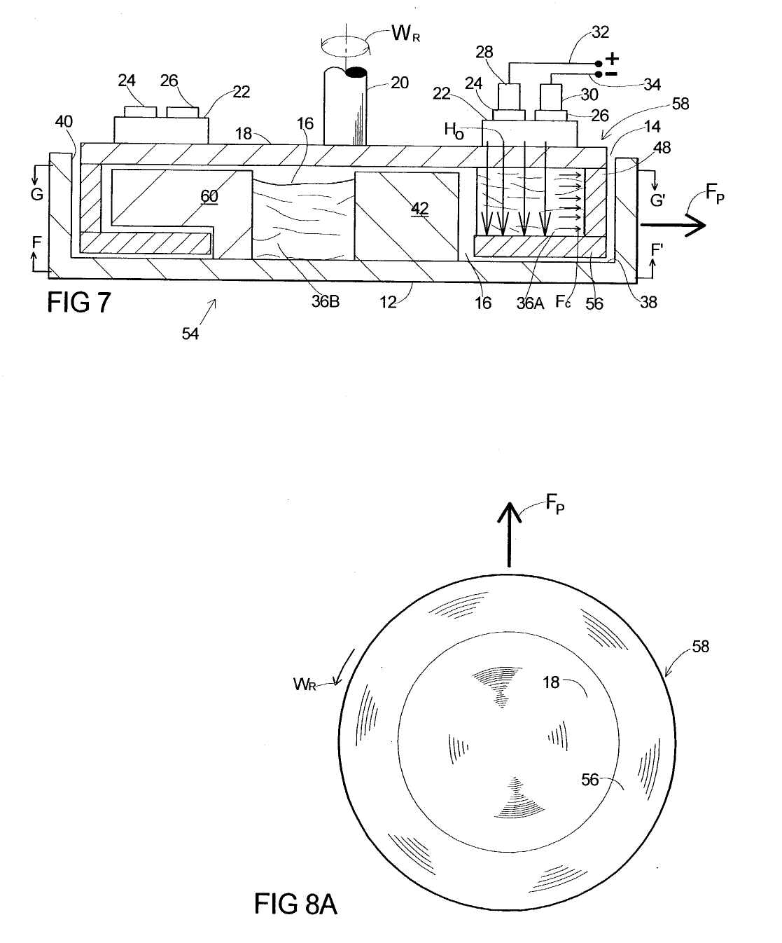

FIG. 7 is a further improvement in the performance of the hydromagnetic inertial thruster 46 shown in FIG. 4; which is also a further improvement on the hydromagnetic inertial thruster 10. FIG. 7 shows a hydromagnetic inertial thruster 54, a hydrodynamic stator 12 with a stator chamber 14 and a closed circuit channel 16. The stator chamber 14 has a chamber floor 38 and a chamber wall 40. The chamber 14 also has a front island 42, and a rear island 60 to accommodate the new change. Both islands 42 and 60 define the shape of the closed circuit channel 16. In the stator 12, the stator chamber 14 houses the assembly of a centrifugal platform 58. The platform 58 is comprised by a centrifugal force generator 18, a centrifugal thrust wall 48, and a centrifugal floor 56. The centrifugal force generator 18 is attached to a generator shaft 20. The shaft 20 is attached to a motor that is not shown and provides the torque to rotate the generator 18 with an angular velocity W_{R}. A plurality of electromagnets 22 (only two are shown) with an electric contact 24 and a second electric contact 26 are provided to transfer electricity to the electromagnet 22. A set of electric brushes 28 and 30, each with a corresponding electric conductor 32 and 34 connect to an external electric power source symbolized with the symbols +and −. Each of the electromagnet contacts 24 and 26 make a direct connection with a corresponding electric brush 28 and 30 to power the electromagnet 22 in order to generate a magnetic field Hₒ. On the right side of FIG. 7, the magnetic field Hₒ acts as a magnetic container to attract and hold a mass of hydromagnetic fluid 36A. A second phase of hydromagnetic fluid 36B is shown on the chamber floor 38 between the chamber islands 42 and 60. An improved rear island 60 replaces the previous island 52 in order to accommodate the operation of the centrifugal floor 56. With a mass of fluid 36A, the centrifugal platform 58 rotates counterclockwise with the angular velocity W_{R} to generate an unbalanced centrifugal force F, that generates a directional propulsion force Fₚ.

In FIG. 4, the addition of the inertial wall 48 was added to increase the hydromagnetic thruster 10 performance. Similarly, as the angular velocity W_{R} continues to increase, the magnitude of the centrifugal force F_{c} also continue to increase. The continuous magnitude increase in the centrifugal forces F_{c} compels the volume of fluid 36A to expand and eventually it touches the chamber floor 38. The addition of the centrifugal floor 56 forms an annular container to hold the mass of fluid 36A within at the higher velocities W_{R}. As a result, a higher magnitude of unbalanced centrifugal forces F_{c} output develops to yield a higher overall gain in the magnitude of the propulsion thrust Fₚ.

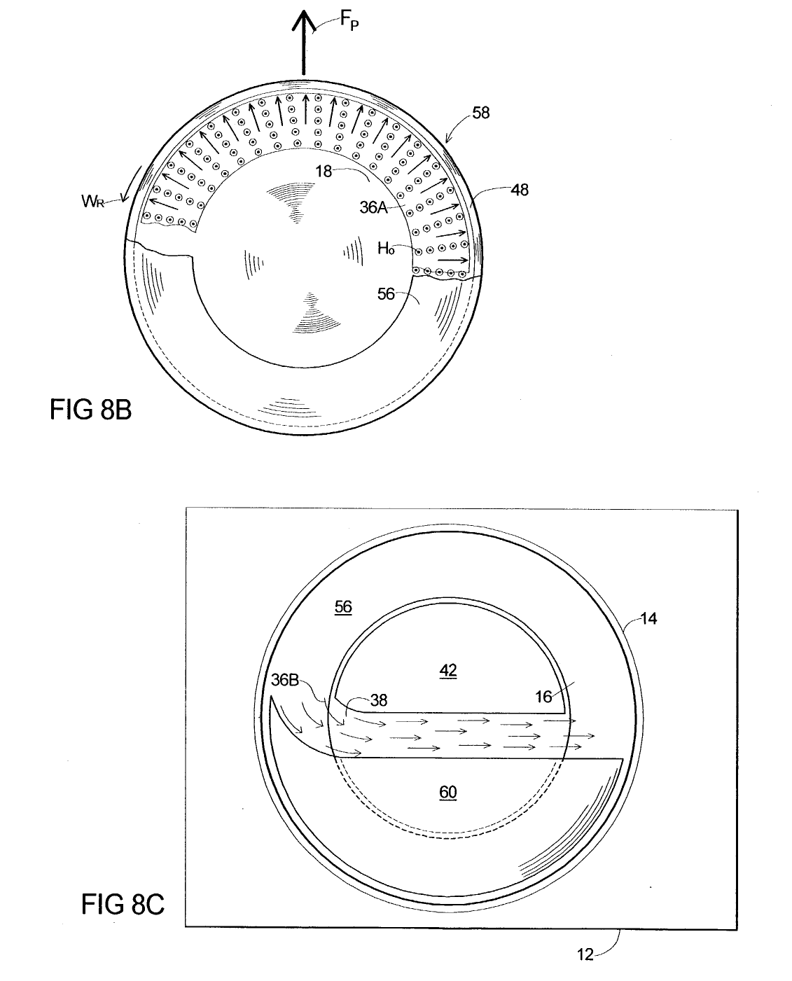

FIG. 8A shows a view of the annular floor 56 introduced in FIG. 7. This view is taken along the line FF′ to isolate the centrifugal platform 58 from the rest of the components. FIG. 8A shows a centrifugal platform 58, a centrifugal force generator 18 with a centrifugal floor 56 rotating at an angular velocity W_{R} to generate the directional propulsion force Fₚ. The centrifugal generator 18 is a disk shaped rotor supporting a plurality of electromagnets 22 on one face. At the periphery and perpendicular to the opposite face, the centrifugal generator 18 supports a ring shaped vertical wall, the centrifugal thrust wall 48. At the opposite end of the wall 48, the centrifugal floor 56 is attached. The floor 56 is a horizontal annular wall shaped like the familiar flat washer, as shown in FIG. 8A. In the view of FIG. 8A, the fluid 36A operation is not shown since it is blocked from view by the floor 56. FIG. 8B is a continuation of FIG. 8A.

FIG. 8B shows a centrifugal generator 18, an inertial wall 48, and a centrifugal floor 56 assembled as a centrifugal platform 58. FIG. 8B also shows a mass of hydromagnetic fluid 36A supported by a magnetic field Hₒ and rotate together with the centrifugal platform 58 with the angular velocity W_{R} to generate the unbalanced centrifugal force F_{c}. The vector sum of all the centrifugal force F_{c} components in the fluid 36A become the directional propulsion force Fₚ. FIG. 8B is a repetition of FIG. 8A with a portion of the centrifugal floor 56 cut out to show the operation of the hydromagnetic fluid 36A.

FIG. 8C is a view of the hydrodynamic stator 12 taken along the line GG′ of FIG. 7. FIG. 8C shows a hydrodynamic stator 12, a stator chamber 14, a closed circuit channel 16, a phase of hydromagnetic fluid 36B, a chamber floor 48, a front island 42, a centrifugal floor 56, and a rear island 60. FIG. 8C shows the phase of fluid 36B after it has been released by the centrifugal platform 58 into the channel 16. As the figure shows, the phase of fluid 36B encounters the rear island 60 and changes direction as shown with arrows. The fluid 36B flows over the chamber floor 38 between the islands 42 and 60. The phase of fluid 36B flows back into the platform 58 to repeat the hydromagnetic propulsion thrust cycle again. In FIG. 8C, the centrifugal floor 56 is shown in the drawing only to demonstrate the structural relationship between the components in the stator chamber 14. In the space between the chamber floor 38 and the rear island 60, the centrifugal floor 56, as part of the centrifugal platform 58, rotates with the angular velocity W_{R}. The inner dashes line represents the trunk of the island 60. While the outer dashed line represents the inner edge on the floor 56. The lateral profile can be seen in FIG. 7. The propulsion operation of the hydromagnetic inertial thruster 54 employs the thrust cycle T1. The hydrodynamic stator 12 with the chamber 14 and the islands 42 and 62 provide the functional means to support the operation of the platform 58. The hydromagnetic thruster 54 also employs the propulsion thrust cycle T1.

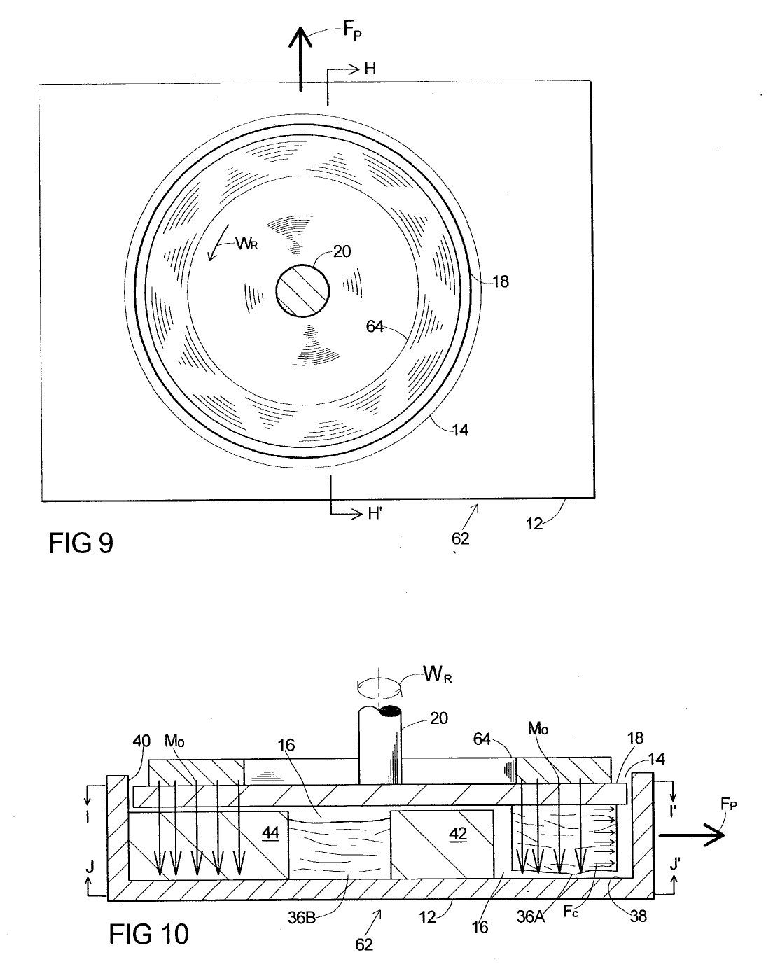

FIG. 9 is another version of the hydromagnetic inertial thruster 10. FIG. 9 shows a hydrodynamic inertial thruster 62 comprising a hydrodynamic stator 12, a stator chamber 14, a centrifugal force generator 18 attached to a generator shaft 20 and a magnet 60. The generator 18 together with the magnet 60 rotates at an angular velocity W_{R} to produce a directional propulsion force Fₚ. The use of a magnet 60 on the hydromagnetic thruster 62 eliminates all the electric means for generating a magnetic field.

FIG. 10 is a cross sectional view of the inertial propulsion thruster 62 taken along the HH′ of FIG. 9. FIG. 10 shows a hydromagnetic inertial thruster 62 comprising a hydrodynamic stator 12 with a stator chamber 14 and a closed circuit channel 16. The stator chamber 14 has a chamber floor 38 and a chamber wall 40. The chamber 14 also has a front island 42 and a second rear island 44 manufactured from a suitable material for the operation. The stator 12, in the stator chamber 14 accommodates a centrifugal force generator 18 attached to a generator shaft 20. The shaft 20 is attached to a motor (not shown) that provides the torque to rotate the generator 18 with an angular velocity W_{R}. A magnet 64 acts as a source of magnetic field Mₒ. On the right side of FIG. 10, the magnetic field Mₒ acts as a magnetic container to attract and hold a mass of hydromagnetic fluid 36A. A second phase of hydromagnetic fluid 36B is shown between the islands 42 and 44 over the floor 38. As it occurs in the invention, the hydromagnetic fluid 36 has two phases. The phase of hydromagnetic fluid 36 under the influence of the magnetic field Mₒ that translate with the generator 18 will also be described with the numeral 36A. While the numeral 36B will also refer to the phase of hydromagnetic fluid 36 that is free from the influence of the magnetic field Mₒ and flows between the islands 42 and 44 over the floor 38. In the invention, both, the electromagnet 22 and the magnet 64 are the sources of magnetic field. Therefore, a magnetic field Hₒ or Mₒ has the same effect on the hydromagnetic fluid phase 36A. The centrifugal force generator 18 rotates counterclockwise with an angular velocity W_{R} to generate a centrifugal force F_{c} in the fluid phase 36A. The unbalanced centrifugal force F_{c} generates the directional propulsion force Fₚ. In the construction of the hydromagnetic thruster 62, the preferred material for making the rear island 44 should be a very low induction non magnetic or a non metallic material to minimize any induction drag generated by the magnetic field Mₒ as it moves through the island 44. The stator chamber 14 is a hollow depression in the body of the hydrodynamic stator 12 defined by the boundaries of the space between the floor 38 and the chamber wall 40.

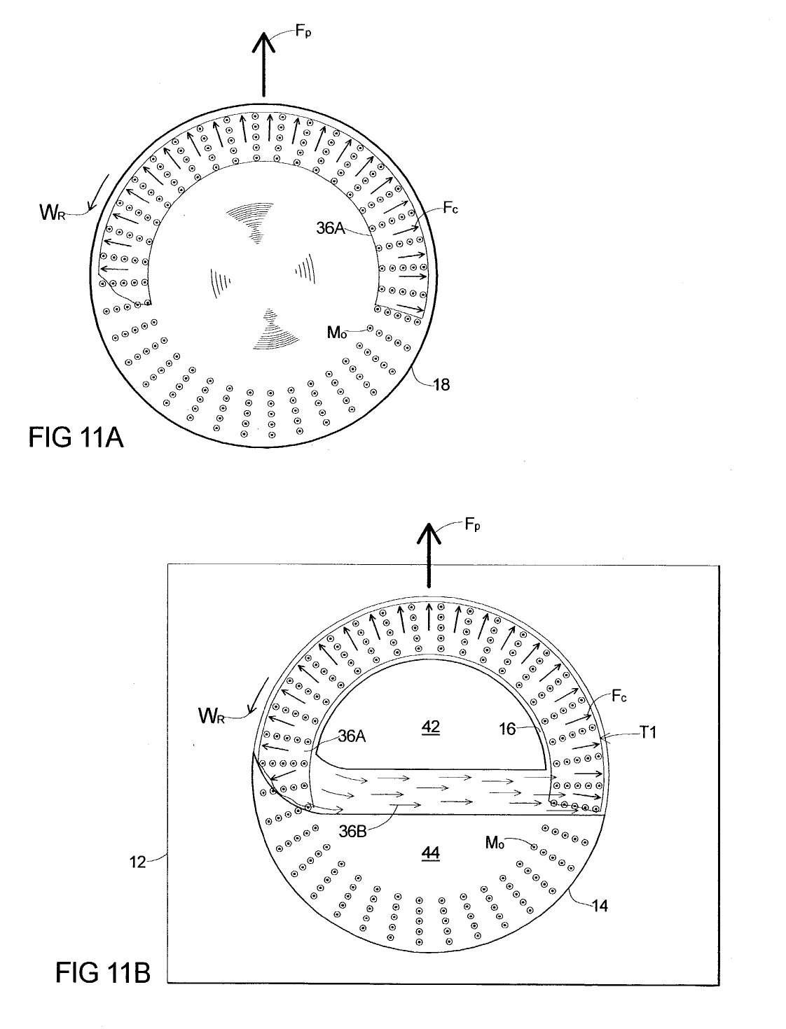

FIG. 11A is a view of the centrifugal force generator 18 only taken along the line JJ′ of FIG. 10. It shows a magnetic field Mₒ that emanates from the magnet 64 (not shown in this view) located on the back side of the generator 18. The centrifugal generator 18 rotates with the angular velocity W_{R} while holding on to a mass of hydromagnetic fluid 36A. The phase of fluid 36A generates the additional unbalanced centrifugal forces F_{c} that go on to generate a directional propulsion force Fₚ. FIG. 11A shows that, the magnetic field Mₒ is distributed over an annular area on the outer perimeter of the generator 18.

FIG. 11B is a view of the hydrodynamic stator 12 taken along the line II′ of FIG. 10. It shows a hydrodynamic stator 12, a stator chamber 14, a closed circuit channel 16, a phase of hydromagnetic fluid 36A and a phase of hydromagnetic fluid 36B, a front island 42, a rear island 44, a centrifugal force F_{c} marked with a plurality of radial arrows, a propulsion thrust cycle T1, an angular velocity W_{R}, and a directional propulsion force Fₚ. FIG. 11B is a visual summary of the propulsion thrust cycle T1 taking place in the inertial thruster 62. It shows the hydromagnetic fluid operation in both the rotor generator 18 and the stator 12 superimposed inside the channel 16. A noticeable difference between FIG. 11B and FIG. 3C is the distribution of the magnetic field Mₒ. As shown in FIG. 11A, the magnetic field Mₒ emanating from the magnet 64 on the generator 18 penetrates into the rear island 44. However, as the disk of the generator 18 rotates to complete a cycle of revolution, the field Mₒ does not transport any significant amount of fluid 36A over the island 44. That is assuming that the gap between the generator 18 and the island 44 is small and within close tolerance. The inertial thruster 62 employs the propulsion thrust cycle T1 to generate the directional propulsion force Fₚ.

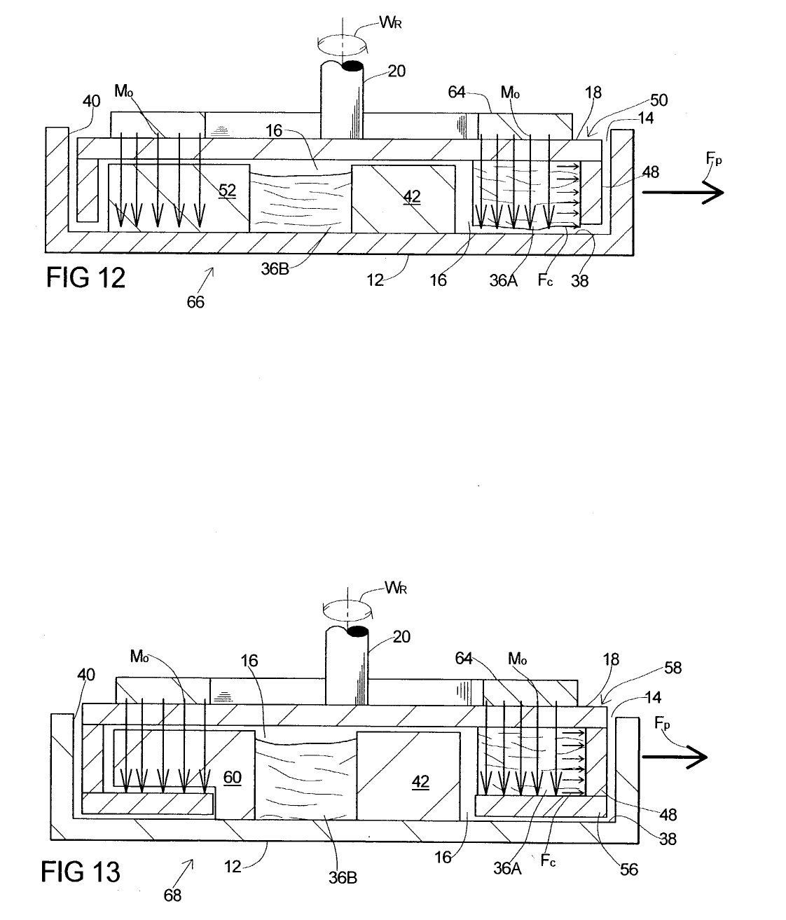

FIG. 12 is similar in operation to the hydromagnetic thruster 46 shown in FIG. 4. FIG. 12 shows a hydrodynamic inertial thruster 66 comprising a hydrodynamic stator 12, a stator chamber 14, a closed circuit channel 16, a centrifugal force generator 18 attached to a generator shaft 20, a magnet 64 that provide a magnetic field Mₒ to attract, hold, and support a mass of hydromagnetic fluid 36A, a mass of hydromagnetic fluid 36B, a chamber floor 38, a chamber wall 40, a front island 42 and a second rear island 52 made of a suitable material, a centrifugal thrust wall 48, and a centrifugal platform 50 comprised by the centrifugal generator 18 and the centrifugal thrust wall 48. The centrifugal platform 50 rotates counterclockwise with an angular velocity W_{R} to generate a centrifugal force F_{c} in the body of fluid 36A. The vector sums of all the centrifugal force F_{c} components generate a directional propulsion force Fₚ. The inertial thruster 66 operates with the propulsion thrust cycle T1.

FIG. 13 is a further improvement on the hydromagnetic inertial thruster 66. FIG. 13 shows a hydrodynamic inertial thruster 68 comprising a hydrodynamic stator 12, a stator chamber 14, a closed circuit channel 16, a centrifugal force generator 18 attached to a generator shaft 20, a magnet 64 to provide a magnetic field Mₒ that attracts and support a mass of hydromagnetic fluid 36A. The thruster 68 also has a mass of hydromagnetic fluid 36B, a chamber floor 38, a front island 42 and a second rear island 60 shaped to accommodate a centrifugal floor 56, a chamber wall 40, a centrifugal thrust wall 48, and a centrifugal platform 58 comprised by the centrifugal generator 18, the vertical wall 48 and the horizontal centrifugal floor 56. The centrifugal platform 58 rotates counterclockwise with an angular velocity W_{R} to generate a body of centrifugal forces F_{c} in the mass of fluid 36A. The vector sums of all the unbalanced centrifugal force F_{c} components generate a directional propulsion force Fₚ. The hydromagnetic inertial thruster 68 operates with the propulsion thrust cycle T1. For the construction of the island 60, a low inductance material would be preferred to minimize the magnetic field Mₒ induction as the field Mₒ passes through the body of the island 60.

In general, a comparison between the propulsion thrust cycle T1 description given in FIG. 3C and FIG. 11B shows that, the use of the electromagnet 22 allows a greater degree of flexibility and control as to the location of the final position where the phase of fluid 36A separates and becomes the phase of fluid 36B. FIG. 11B shows that since the magnetic field Mₒ is continuous, the fluid phase 36A separates at the arcuate front face of the rear island 44. The same thing can be achieved with the electromagnet 22. However, FIG. 3C shows that the magnetic field Hₒ can be terminated early before it reaches the obstacle presented by any of the rear islands 44, 52 or 60. However, as a generalization only, it will be assumed that the thrust cycle T1 is the same for a hydromagnetic inertial thruster employing either the electromagnet 22 or the magnet 64 as a magnetic field source. In the inertial thrusters 62, 66 and 68, instead of the singular annular source of magnetic field 64, a plurality of suitable magnet segments can be used as an alternate source.

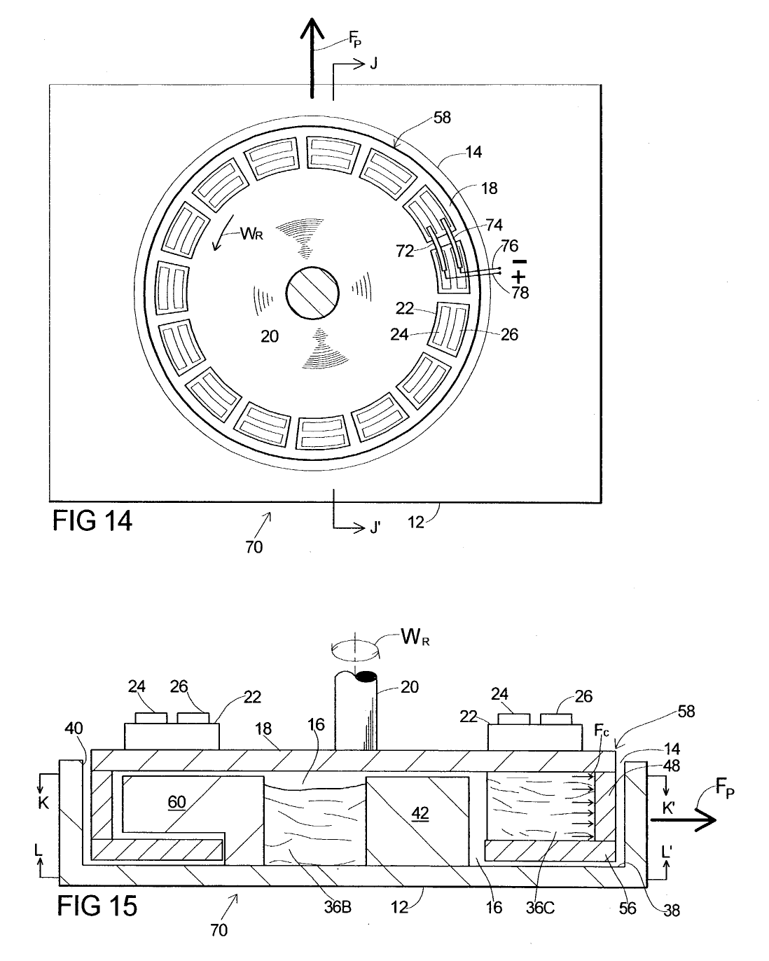

FIG. 14 is a top plan view of a hydromagnetic inertial thruster 70 comprising a hydrodynamic stator 12, a stator chamber 14, a centrifugal force generator 18 attached to a generator shaft 20, a plurality of electromagnets 22, a pair of electric contacts 24 and 26, a centrifugal platform 58, a pair of electric brushes 72 and 74 each with corresponding electric conductors 76 and 78 connected to a power supply symbolized with the + and − signs, an angular velocity W_{R}, and a directional propulsion force Fₚ.

FIG. 15 is a cross sectional view of the hydromagnetic inertial thruster 70 taken along the line JJ′ of FIG. 14. FIG. 15 shows a hydromagnetic inertial thruster 70 comprising a hydrodynamic stator 12 with a stator chamber 14, a closed circuit channel 16, a centrifugal force generator 18, a generator shaft 20, electromagnet 22 with electric contacts 24 and 26, a phase of hydromagnetic fluid 36B, a phase of hydromagnetic fluid 36C, a chamber floor 38 and a chamber wall 40, a front island 42, a rear island 60, a centrifugal thrust wall 48, a centrifugal floor 56, and a centrifugal platform 58. The platform 58 is comprised by the assembly of the centrifugal generator 18, the vertical wall 48, and the horizontal floor 56. In the chamber 14, both islands 42 and 60 assist in defining the contour of the closed circuit channel 16. In the stator 12, the stator chamber 14 houses the centrifugal platform 58 attached to the generator shaft 20. The shaft 20 is attached to a motor that is not shown and provides the torque to rotate the platform 58 with an angular velocity W_{R}. A plurality of electromagnets 22, each with electric contacts 24 and 26 are provided to transfer electricity to any electromagnet 22 in order to generate a magnetic field Hₒ. On the right side of FIG. 15, a mass of a hydromagnetic fluid 36C generates an unbalanced centrifugal force F,, marked with arrows. Another phase of the hydromagnetic fluid 36B is shown between the islands 42 and 60. In general, the hydromagnetic fluid will be referred to with the numeral 36. For this invention, a hydromagnetic fluid is defined as a colloidal ferrofluid or any other type of fluid that generates a substantial response in the presence of a magnetic field. As it occurs in this latest improvement, the hydromagnetic fluid 36 has three phases applicable to the operation of the hydromagnetic inertial thruster 70. The phase of hydromagnetic fluid 36 under the influence of the magnetic field Hₒ, operating in the centrifugal platform 58 will be described with the numeral 36A. The second phase is given the numeral 36B; and refers to the phase of hydromagnetic fluid 36 free from the influence of the magnetic field Hₒ and flows in the stator channel 16 over the chamber floor 38 in between the islands 42 and 60. The third phase of the hydromagnetic fluid 36 that operates in the centrifugal platform 58 without the presence of the magnetic field Hₒ will be identified as 36C. The centrifugal platform 58 rotates counterclockwise with an angular velocity W_{R} to generate the centrifugal force F_{c} that generates a directional propulsion force Fₚ. In FIG. 15 only two electromagnets 22 are shown.

The hydromagnetic inertial drive 70 is a further improvement in the operation of hydromagnetic inertial propulsion. The hydromagnetic thruster 70 is similar to the construction of the hydromagnetic inertial thruster 54 with the noted exception in the length of the brushes 72 and 74; which implies a different hydromagnetic thrust cycle operation.

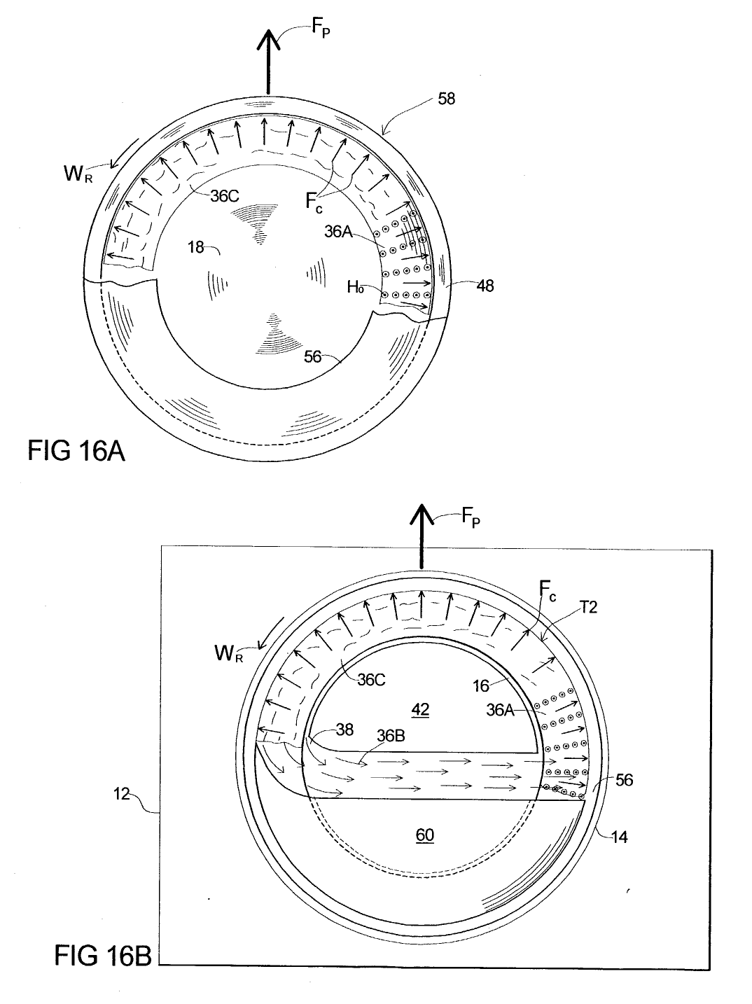

Referring to FIGS. 14 and 15, the electric brushes 72 and 74 employed to power the electromagnet 22 in the hydromagnetic thruster 70 are shorter than the previous brushes 28 and 30. The shortness of the brushes 72 and 74 are suitable for the improvisation of a new propulsion thrust cycle T2 shown in FIG. 16B. The improved propulsion thrust cycle T2 employs three phases of operation with the hydromagnetic fluid 36. At about the three o'clock position, an electromagnet 22 makes contact with the pair of brushes 72 and 74 and start to generate the magnetic field Hₒ. However, due to the short length of the electric brushes 72 and 74, the magnetic field Hₒ from an electromagnet 22 works only for a short angular distance before it disappears. As the centrifugal platform 58 rotates counterclockwise with a mass of fluid 36C without the magnetic field Hₒ, the phase of fluid 36C also generates the unbalanced centrifugal force F_{c} that produces the directional propulsion force Fₚ. Therefore, in the thruster 70, the hydromagnetic fluid phases 36A and 36C working together generate all the unbalanced centrifugal forces F_{c} produced in the platform 58. The explanation of the thrust cycle for the hydromagnetic thruster 70 continues with the aid of the FIGS. 16A and 16B.

FIG. 16A is a view of the centrifugal platform 58 taken along the line LL′ in FIG. 15. In addition to the centrifugal force generator 18, FIG. 16A shows a mass of hydromagnetic fluid 36A, another mass of hydromagnetic fluid 36C, a centrifugal thrust wall 48, a centrifugal floor 56, centrifugal forces F_{c} marked with radial arrows, an angular velocity W_{R}, and a directional propulsion force Fₚ. In FIG. 16A, the centrifugal floor 56 has a cut out to show with clarity the relevant fluid dynamic operations taking place in the platform 58. Initially, the magnetic field Hₒ in the platform 58 takes a mass of fluid 36A inside the platform 58 and transports it for the short distance of a few degrees. Then the magnetic field Hₒ vanish and the phase of fluid 36A becomes the phase of hydromagnetic fluid 36C. The fluid 36C continues the angular translation with the platform 58 at the angular velocity W_{R}. During this part of the unbalanced centrifugal thrust output operation, both phases of fluid 36A and 36C generate the unbalanced centrifugal forces F_{c} that produce the directional propulsion force Fₚ

FIG. 16B is a view of a hydrodynamic stator 12 taken along the line KK′ of FIG. 15. FIG. 16B shows a hydrodynamic stator 12, a stator chamber 14, a closed circuit channel 16, a chamber floor 38, a front island 42, a centrifugal floor 56, and a rear island 60, the phases of hydromagnetic fluid 36A, 36B, and 36C, a propulsion thrust cycle T2, angular velocity W_{R}, and the centrifugal forces F_{c} that produce the directional propulsion force Fₚ.

Stating with FIG. 14 and continuing with FIGS. 15, 16A and 16B, the shortness of the electric brushes 72 and 74 will allow a single electromagnet 22 to produce a magnetic field Hₒ for only for a brief period of time in a cycle of revolution. From the initial position where an electromagnet 22 till turn on, and until a short distance later when the electromagnet 22 loses the electric contact with the brushes 72 and 74 and turns off; the electromagnet generates a magnetic field Hₒ to capture a mass of hydromagnetic fluid 36B. Under the influence of the magnetic field Hₒ, the phase of fluid 36B entering the platform 58 becomes a phase of hydromagnetic fluid 36A (as shown in FIG. 16B). After the electromagnet 22 moves away from the electric brushes 72 and 74 and turns off, the phase of hydromagnetic fluid 36A traveling with the centrifugal platform 58 become the phase of hydromagnetic fluid 36C. The hydromagnetic fluid phase 36C in the platform 58 operates without the magnetic field Hₒ. The phases of hydromagnetic fluid 36A and 36C generate the centrifugal forces F_{c} as they rotate with the centrifugal platform 58. FIG. 15 shows that the fluid 36C occupies part of the annular volume between the disk shaped centrifugal generator 18, the centrifugal thrust wall 48 and the centrifugal floor 56. The fluid phases 36A and 36C rotate together with the platform 58 to produce the centrifugal forces F_{c} that push against the centrifugal thrust wall 48. The vector sums of all the total centrifugal forces F_{c} become the directional propulsion force Fₚ. As the figures show, the phase of fluid 36A and 36C translate with the angular velocity W_{R}. On he left side of FIG. 16B, the mass of fluid 36C encounters the rear island 60 and is deflected into the channel 16 pathway over the floor 38 and between the chamber islands 42 and 60. After the phase of fluid 36C leaves the platform 58, it becomes the phase of hydromagnetic fluid 36B. The mass of fluid 36B travels to the other side of the channel 16 to enter the platform 58 and meet the magnetic field Hₒ to start the thrust cycle T2 all over again. The propulsion thrust cycle T2 represents the inertial thrust output operation just described above and FIG. 16B is a visual summary of the description.

As FIG. 15 shows, the centrifugal floor 56 is attached to the vertical wall 48 and travels between the rear island 60 and the chamber floor 38. In FIG. 16B, the centrifugal floor 56 is included in the drawing only to show the functional relationship and placement inside the stator chamber 14. The description of the hydromagnetic thruster 70 shows only one pair of the power supply brushes 72 and 74. However, instead of only one pair of brushes, a plurality of the brushes 72 and 74 can be used. A plurality of brushes 72 and 74 will allow the hydromagnetic thruster 70 the additional flexibility for making use of the propulsion thrust cycle T1.

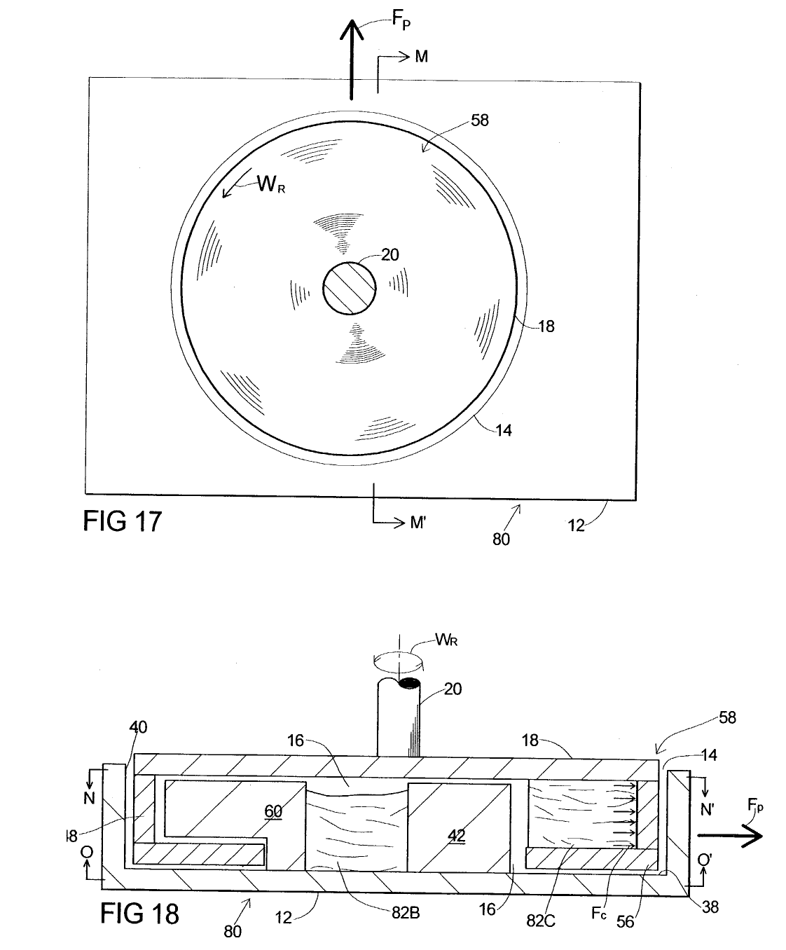

FIG. 17 is a further improvement in field of inertial propulsion. The hydromagnetic propulsion thrust cycle T2 releases the implication of another thrust cycle available in the absence of the magnetic Hₒ operation. The new thrust cycle is shown in the embodiment of a hydrodynamic inertial thruster 80. FIG. 17 is a plan view of a hydrodynamic inertial thruster 80 comprising a hydrodynamic stator 12, a stator chamber 14, a centrifugal force generator 18, a generator shaft 20, a centrifugal platform 58, an angular velocity W_{R}, and a directional propulsion force Fₚ.

FIG. 18 is a cross sectional view taken along the line MM′ of FIG. 17. It shows a hydrodynamic inertial thruster 80 comprising a hydrodynamic stator 12, a stator chamber 14, a closed circuit channel 16, a centrifugal force generator 18 attached to a generator shaft 20, a chamber floor 38, a chamber wall 40, a front island 42, a centrifugal thrust wall 48, a centrifugal floor 56, a centrifugal platform 58, a rear island 60, a phase of fluid 82B, a second phase of fluid 82C generating centrifugal forces F_{c} marked with arrows, an angular velocity W_{R}, and a directional propulsion force Fₚ. The platform 58 is comprised by the centrifugal force generator 18, the centrifugal thrust wall 48 and the centrifugal floor 56.

FIG. 17 and FIG. 18 show that all the sources of magnetic field, the plurality of electromagnets 22, and the ring shaped magnet 64 have been eliminated. As both figures show, the centrifugal platform 58 rotates counterclockwise at the angular velocity W_{R} to generate the centrifugal forces F_{c} in the mass of fluid 82C that produce the directional propulsion force Fₚ. In general, the fluid 82 employed in the hydromagnetic inertial thruster 80 can be of either type a colloidal magnetic fluid or ferrofluid, or a non magnetic fluid such as lubricating oil, water, or any other type of fluid suitable for the operation. However, a non magnetic fluid is the preferred type of fluid for the thruster 80 since a magnetic field will not be used to generate the propulsion thrust Fₚ. In the inertial thruster 80, the fluid 82 undergoes two phases of transformation in the operation to make the centrifugal force F_{c} that generate the directional propulsion force Fₚ. The phases of the fluid 82 operations are marked as 82B and 82C. The phase of fluid 82B operates in the chamber 14 pathway over the floor 38 in between the islands 42 and 60. The phase of fluid 82C operates in the centrifugal platform 58 to generate the unbalanced centrifugal force F_{c}. The explanation continues with the next three figures.

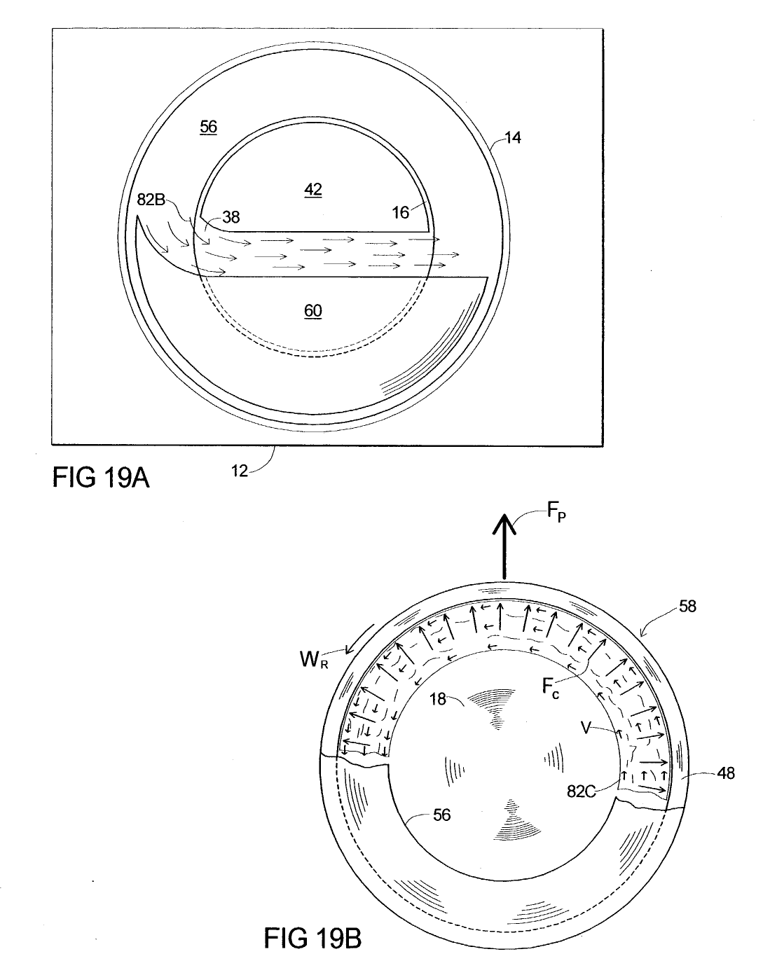

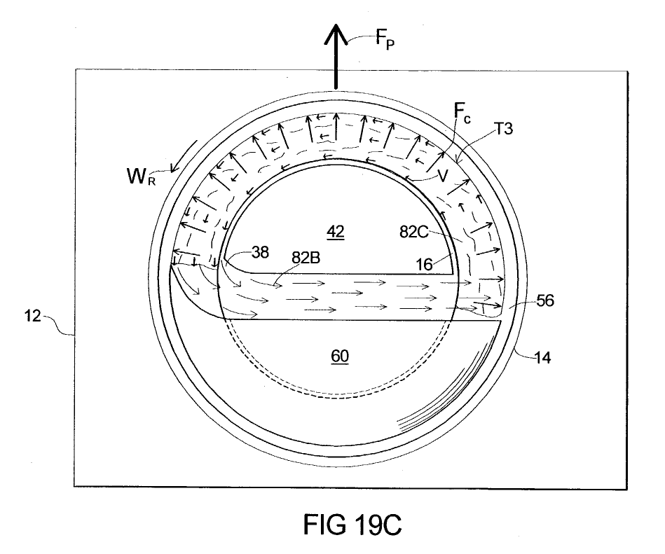

FIG. 19A is a partial view of only the hydromagnetic stator 12 taken from the line NN′ of FIG. 18. It shows a hydrodynamic stator 12, a stator chamber 14, a closed circuit channel 16, a chamber floor 38, a front island 42, a rear island 60, a centrifugal floor 56 and a phase of a fluid 82B. The stator 12 is isolated to show the fluid dynamic in operation as the fluid 82B flows through a section of the channel 16. The centrifugal floor 56 is included in this view to show the construction relationship with respect to the stator chamber 14 and the rear island 60. The floor 56 operates inside the chamber 14 and surrounds the islands 42 and 60. As the dashed lines and the view in FIG. 18 show, the floor 56 operates between the floor 38 and the rear island 60. In FIG. 19A, the fluid flow of a phase of fluid 82B is described with arrows as it travels from the left to the right side of the channel 16 over the floor 38 and between the islands 42 and 60. On the left side of the chamber 14 in FIG. 19A, the mass of fluid 82B is seen as leaving the platform 58 (only the floor 56 ids shown) into a section of the channel 16. Then it flows over the floor 38 in between the islands 42 and 60 towards the right side. As the fluid 82B moves through this section of the channel 16, the mass of fluid 82B generates no significant negative forces to oppose and diminish the vector sum of all the centrifugal forces F_{c} generated by the platform 58. The operation of the fluid flow 82B in the stator 12 is only a part of the total propulsion thrust cycle T3 shown in its entirety in FIG. 19C

FIG. 19B is a view of the centrifugal platform 58 alone taken along the line OO′ in FIG. 18. The platform 58 is isolated to show the fluid dynamic operation in the platform. FIG. 19B shows a centrifugal force generator 18, a centrifugal thrust wall 48, a partial view of an centrifugal floor 56, a mass of fluid 82C translating counterclockwise, a fluid velocity V, an angular velocity W_{R}, a plurality of radial arrows symbolizing a centrifugal force F_{c}, and a directional propulsion force Fₚ. In the rotating platform 58, a mass of fluid 82B from the stator 12 entered the annular space defined by the centrifugal generator 18, the inertial wall 48 and the floor 56 and become a phase of fluid 82C inside the platform 58. The mass of fluid 82C then rotates counterclockwise together with the platform 58 at the angular velocity W_{R}. Inside the platform 58, a fluid velocity V component in the fluid 82C represents any velocity variation between the platform 58 and the fluid 82C. Driven by the pumping action of the platform 58, the fluid 82C translate counterclockwise with the platform 58, moving from right to left in a semicircular orbital path. At the end of the semicircular orbital path on the left side, the fluid 82C encounters the rear island 60 and exits the platform 58 (as shown in FIG. 19A). The island 60 in the stator chamber 14 makes the phase of fluid 82C depart from the rotating platform 58. The mass of fluid 82C that left the platform 58 then becomes the phase of fluid 82B as shown in FIG. 19A. As the platform 58 continues rotating to finish a cycle of revolution, the back of the platform 58 does not carry any of the fluid 82C. As the illustration shows, the angular velocity W_{R} generates the centrifugal force F_{c} marked with radial arrows. With a load of fluid 82C on only one side of the platform 58, the unbalanced of the centrifugal forces F_{c} generate the directional propulsion force Fₚ. The operation of the fluid flow 82C in the centrifugal platform 58 is also another part of the total propulsion thrust cycle T3 shown in its entirety in FIG. 19C

FIG. 19C is a visual summary description of the operations of the propulsion thrust cycle T3 illustrated in FIGS. 19A and 19B. FIG. 19C shows a hydrodynamic stator 12, a stator chamber 14, a closed circuit channel 16, a chamber floor 38, a front island 42, a rear island 60, a phase of fluid 82B, a phase of fluid 82C, a fluid velocity V, an angular velocity vector W_{R}, a centrifugal force Fc, a directional propulsion force Fₚ, a propulsion thrust cycle T3. FIG. 19C is a visual description of a complete propulsion thrust cycle T3.

FIG. 19C is put together as a visual illustration of the propulsion thrust cycle T3. The fluid dynamic operations in the stator 12 and in the platform 58 are superimposed together in the stator chamber 14 to explain the operation of the propulsion thrust cycle T3. As the centrifugal platform 58 (only the floor 56 is shown in this figure) rotates with the angular velocity W_{R}, it receives a mass of fluid 82B from the hydrodynamic stator 12. In the platform 58, the phase of fluid 82B becomes the phase of fluid 82C. The rotating platform 58 transport the mass of fluid 82C approximately 180° counterclockwise where the fluid 82C encounters the rear island 60. The island 60 compels the fluid 82C to exit the platform 58 and into the channel 16 as shown on the left side of FIG. 19C. The island 60 then turns the mass of fluid 82B in a new direction and guides it over the floor 38 between the islands 42 and 60 towards the right side of the channel 16. On the right side of the channel 16, the phase of fluid 82B enters the platform 58 once again, and the propulsion thrust cycle T3 start to repeat all over again. The semicircular orbital translation path of a mass of fluid 82C produces the centrifugal force components F_{c} that generate the directional propulsion force Fₚ. The thrust cycle T3 has a repetitive continuity due to the continuous exchange of masses of fluid 82B and 82C between the stator 12 and the rotating platform 58 and vice versa. A mass of fluid 82B leaves the stator 12 and enters the platform 58; and a mass of fluid 82C leaves the platform 58 and enters the stator 12 again. Both operations in the stator 12 and the platform 58 occur in a continuous repetitive pattern. Inside the platform 58, the frictional forces between the fluid 82C and the inner surface of the platform 58 exert a pumping action on the mass of fluid 82C.

In FIG. 19C, the fluid velocity V component in the fluid 82C is shown with tangential arrows. The fluid velocity V is and indicator of any velocity differential between the fluid 82C and the platform 58. The velocity V has several implications. One of the implications is that, if the velocity V add to the fluid velocity W_{R} in the platform 58, then the additional fluid velocity component V will add to the total magnitude of the centrifugal forces F_{c} produced by the mass of fluid 82C. The implication is that, a higher total fluid 82C velocity (W_{R}+V) will produce an additional increase in the magnitude of the centrifugal forces F_{c}. That increase will yield a further increase in the directional propulsion thrust Fₚ output. This implication indicates that, adding a fluid pumping mechanism inside or outside the inertial thruster 80 can increase the overall propulsive thrust output of the system.

Another implication of the thrust cycle T3 is that; in the hydromagnetic inertial thrusters 54 and 70, with the magnetic field Hₒ turned off, both inertial thrusters 54 and 70 will operate with the thrust cycle T3 and they will continue to generate a propulsion force Fₚ. An additional implication for hydromagnetic propulsion is that, in the same manner a synchronous magnetic field drives a rotor in an electric motor, in a hydromagnetic inertial thruster, a synchronous magnetic field Hₒ can be used to induce additional velocity components in a hydromagnetic fluid. The last implication relates to the augmentation of the hydromagnetic thrust output by the utilization of a plurality of electromagnets 22, or any suitable circuitry and electromagnetic core to add a velocity V component to the phase of hydromagnetic fluid 36A. In an electric motor, a synchronous magnetic field rotating in the stator produces a torque that drives the rotor to follow the magnetic field at a synchronous velocity. Similarly, in a phase of hydromagnetic fluid 36C, a suitable source of magnetic field can be utilized to induce a synchronous velocity V component in the hydromagnetic fluid 36A. Another thrust augmentation improvement would be the addition of a means for pumping the fluid 82. The pumping mechanism can be added to either the centrifugal generator 18, the centrifugal platform 58, or to the stator 12. The outcome is a further increase in the magnitude of the centrifugal force F_{c} with a further increase in the magnitude of the directional propulsion force Fₚ.

### CONCLUSION, RAMIFICATIONS, AND SCOPE OF INVENTION

Accordingly, the descriptions given above disclose a novel invention in the field of propulsion. A new propulsion thrust cycle utilizing the centrifugal forces in a fluid that generate a directional propulsion force has been presented.

In the description of the invention, a front island 42 has been included. The island 42 can be eliminated leaving only a rear island that can be modified and adapted in the stator chamber 14. An electric source of magnetic field, the electromagnet 22, has been referred to in the description of the invention. There are many other types of electric sources of magnetic field that can be employed in the invention. For example, a suitable annular ferromagnetic core with winding can be equally useful.

In the descriptions of the hydromagnetic inertial thrusters 46, 54, 66, 68, and 70, only two types of magnetic field sources are employed, the plurality of electromagnets 22 and a magnet 64. In the thrusters 46 for example, a suitable plurality of electromagnets can be added surrounding the centrifugal thrust wall 48. Similarly, a suitable annular magnet can be added to the wall 48 in the inertial thruster 66. In the inertial thruster 54 and 70, a suitable plurality of electromagnets can be added to either to the wall 48, the floor 56, or both. In the drawings, the plurality of electromagnets 22 and the magnet 64 are shown outside of the chamber 14, with no direct contact with the phase of hydromagnetic fluid 36A. These sources of magnetic field (22 and 64) can also be installed inside the chamber 14; in direct contact with the phase of hydromagnetic fluid 36A by making the proper modifications.

Inside the stator chamber 14, the closed circuit channel 16 in the drawings has the shape of a capital letter D, or the semicircular shape of one half of a circle. Using as an example and for comparison only the shape of the letter D, the unbalanced centrifugal force thrust is produced in the semicircular portion of the letter D. While in the straight section of the letter D, minimum opposing forces are produced that do not cancel the centrifugal forces produced in the arcuate section of the letter D. Most of the opposing forces are produced in the corner of the D where the fluid flow turns into the straight section. There are many other suitable fluid transition shapes and profiles that can be used to minimize the opposing forces. For example, instead of a complete straight section in the channel 16, a segment of a circle can be used to return the fluid flow back to the centrifugal thrust generating platform. The shape of the channel 16 gives an indication that the invention makes use of variable radius and variable velocity in the operation of the propulsion thrust cycle.

As a means of propulsion, a single, a dual or a plurality of counter-rotating units can be attached to the chassis of a vehicle to generate motion for transportation. A fluid-inertial propulsion thruster can be employed to propel railway cars, passenger cars, trucks and vans.

In aviation, an inertial fluid thruster can be used for propulsion instead of the usual propeller, turboprop, ramjet, or a jet engine. As a benefit, a considerable reduction in fuel consumption will result; with a consequential reduction in the cost of aircraft operation.

In the field of space exploration, an inertial fluid propulsion thruster has the advantage that no propellant is required for the spacecraft propulsion. An inertial fluid thruster can be operated with an electric motor and electricity from the sun and nearby stars, or from any onboard power plant.

From the descriptions and explanations above, the reader will see that a hydromagnetic inertial thruster is a novel and efficient thrust generator.

The above descriptions and specificities are merely illustrations of some of the presently preferred embodiments and these should not be construed as limiting the scope of the invention. There are many more implied derivatives, combinations, and ramifications beyond those illustrated in the text.

I claim:

1. A directional force generator comprising a disk shaped rotor, electromagnetic means to generate a magnetic field, a magnetically susceptible fluid medium, a housing means to support the operation of said rotor with said fluid, whereby the operation of said rotor with said electromagnetic means generating a magnetic field supports said fluid to generate an unbalance centrifugal forces that generate a directional propulsion force.

2. A directional force generator comprising a centrifugal platform comprised by a disk shaped rotor and a perpendicular annular wall at about the outer periphery of said disk, a plurality of electromagnetic means to generate a magnetic field, a magnetically susceptible fluid medium, a housing means to support the operation of said platform, whereby the operation of said platform with said electromagnetic means providing a magnetic field supports said fluid to generate an unbalance centrifugal force that generate a directional propulsion force.

3. A directional force generator comprising a centrifugal platform comprised by a disk shaped rotor with a perpendicular first annular wall at about the outer periphery of said disk and another annular wall perpendicular to said first wall, a plurality of electromagnetic means to generate a magnetic field, a magnetically susceptible fluid medium, a housing means to support the operation of said platform, whereby the operation of said platform with said electromagnetic means providing a magnetic field supports said fluid to generate an unbalance centrifugal force that generate a directional propulsion force.

4. A directional force generator comprising a disk shaped rotor, a magnet, a magnetically susceptible fluid medium, a housing means to support the operation of said rotor, whereby the operation of said rotor with said magnet providing a magnetic field supports said fluid to generate an unbalance centrifugal force that generate a directional propulsion force.

5. A directional force generator comprising a centrifugal platform comprised by a disk shaped rotor and an annular wall perpendicular at about the outer periphery of said disk, a magnet, a magnetically susceptible fluid medium, a housing means to support the operation of said platform, whereby the operation of-said platform with said magnet providing a magnetic field supports said fluid to generate an unbalance centrifugal force that generate a directional propulsion force.

6. A directional force generator comprising a centrifugal platform comprised by a disk shaped rotor with a first annular wall perpendicular at about the outer periphery of said disk and a second annular wall perpendicularly to said first wall, a magnet, a magnetically susceptible fluid medium, a housing means to support the operation of said platform, whereby the operation of said platform with said magnet providing a magnetic field supports said fluid generate an unbalance centrifugal force that generate a directional propulsion force.

7. A directional force generator comprising, a centrifugal platform comprised by a disk shaped rotor with a first annular wall perpendicular at about the outer periphery of said disk and a second annular wall perpendicular to said first wall, a fluid medium, a housing means to support the operation of said platform, whereby the operation of said platform with said fluid generates an unbalance centrifugal force that generate a directional propulsion force.
